(19) United States
(12) Patent Application Publication
(10) Pub. No.: US 2023/0180771 A1
(43) Pub. Date: Jun. 15, 2023

(54) PULLING DEVICE

(71) Applicant: MAREL BRASIL COMERCIAL E INDUSTRIAL LTDA, Guapore (BR)

(72) Inventors: Henrique ROOS, Guapore (BR); Eder BRAMBATTI, Guapore (BR); Roberto DILL PAULA, Guapore (BR); Adalberto KLOSE, Guapore (BR)

(21) Appl. No.: 17/919,367

(22) PCT Filed: Apr. 22, 2021
(86) PCT No.: PCT/BR2021/050167

§ 371 Date: Oct. 17, 2022

(30) Foreign Application Priority Data
Apr. 24, 2020 (BR) 10 2020 008183-7
Apr. 6, 2021 (BR) 10 2021 006562-1

(51) Int. Cl. A22C 17/14; A22C 17/16

(52) U.S. Cl. CPC A22C 17/14; A22C 17/16

(57) ABSTRACT

A pulling device used in the processing of small intestines of slaughtered animals, such as cattle, pigs and sheep includes a pulling device having at least one rotating wheel. Each rotating wheel has a first side, a second side and a circumferential surface defining a traction channel. Each rotating wheel is fixed on a shaft driven by a motor. The motor is supported on a base. The pulling device has at least one safety cover with a first portion and a second portion. The portions define a closed position, in which the portions cover the sides of the respective rotating wheel, and an open position, in which at least one of the portions is moved away from a respective side of the respective rotating wheel.

### TECHNICAL FIELD

The invention relates to a pulling device used in the processing of small intestines of slaughtered animals, such as cattle, pigs and sheep.

### PRIOR ART

In the meat industry, the small intestine of a slaughtered animal is processed in order to create a casing, which is used in the manufacture of embedded foods. At the beginning of processing, the small intestine is attached to a viscera package through a membrane called the mesentery. The first step is to separate the small intestine from the viscera package. Commonly, this step is performed manually by two operators, with one operator detaching the small intestine from the mesentery with the aid of a cutting device, while the other operator continuously pulls the small intestine in order to move it away from the viscera package. At the end of this step, the small intestine is configured as a line of, for example, approximately 30 meters in the case of cattle, and later it is processed in additional steps, such as removal of excrement and removal of mucosa, in order to originate the casing. However, the manual operation of pulling the small intestine is exhausting, since the operator must perform this pull several times, in an uncomfortable position.

To solve this problem, a pulling device is used, which pulls the small intestine, so that the separation operation can be performed by only one operator. A conventional pulling device is manufactured by the company Holdijk and comprises a rotating wheel having a circumferential surface that defines a traction channel. The rotating wheel is fixed on a shaft driven by a motor, and said motor is supported on a base. To perform the small intestine separation step, the operator performs an initial cut in the mesentery, obtaining a free end of the small intestine, which is then inserted over the traction channel of the rotating wheel. The rotation of the rotating wheel pulls the small intestine, while the operator cuts the mesentery, thus continuously separating the small intestine in order to move it away from the viscera package.

Despite facilitating the operation of separating the small intestine, the conventional pulling device presents risks to the operator's safety due to the fact that the rotating wheel presents a considerable speed, which can cause accidents at work, as, for example, due to an accidental touch at the time when the operator approaches their hand to the rotating wheel to perform the insertion of the small intestine on the traction channel of the rotating wheel.

### SUMMARY OF THE INVENTION

In order to solve the drawbacks present in the prior art, the invention proposes a pulling device comprising at least one rotating wheel, each rotating wheel having a first side, a second side and a circumferential surface defining a traction channel, each rotating wheel being fixed on a shaft driven by a motor, said motor supported on a base. According to the invention, the pulling device comprises at least one safety cover, each safety cover having a first portion and a second portion, the portions defining a closed position, in which said portions cover the sides of the respective rotating wheel, and an open position, in which at least one of the portions is moved away from a respective side of the respective rotating wheel.

Advantageously, when the portions of each safety cover are in the closed position, the sides of each rotating wheel remain covered, in order to prevent an operator from touching the rotating wheel, thus preventing accidents at work. On the other hand, because the portions of each safety cover also define an open position, it is possible to carry out eventual cleaning or maintenance on each rotating wheel in a quick and practical way.

### BRIEF DESCRIPTION OF THE FIGURES

The invention will be better understood with the following detailed description, which will best be interpreted when using the figures, namely:

FIG. 1 shows a perspective view of a first embodiment of a pulling device according to the invention, with a safety cover in a closed position.

FIG. 2 presents an enlarged view of the “A” region indicated in FIG. 1.

FIG. 3 shows a view identical to FIG. 2, but without the representation of a latch.

FIG. 4 shows a front view of the first embodiment of the pulling device.

FIG. 5 shows a sectional view according to the “A-A” cutting plane indicated in FIG. 4.

FIG. 6 shows a sectional view according to the “B-B” cutting plane indicated in FIG. 4.

FIG. 7 presents a perspective view of the first embodiment of the pulling device with the safety cover in an open position.

FIG. 8 shows an enlarged front view of the central region of a rotating wheel visible in FIG. 7, without the representation of a closing plate.

FIG. 9 presents a perspective view of the first embodiment of the pulling device with the safety cover in the open position, without the representation of the rotating wheel.

FIG. 10 shows a sectional view according to the “C-C” cutting plane indicated in FIG. 4.

FIG. 11 presents a bottom perspective view of the first embodiment of the pulling device.

FIG. 12 presents an enlarged view of the “B” region indicated in FIG. 11.

FIG. 13 presents a posterior perspective view of the first embodiment of the pulling device.

FIG. 14 shows a perspective view of the rotating wheel.

FIG. 15 shows a side view of the rotating wheel and an injection device.

FIG. 16 shows a sectional view according to the “D-D” cutting plane indicated in FIG. 15.

FIG. 17 shows a schematic view of a hydraulic-pneumatic circuit for activating a first cleaning device, a movable cleaning device and an injection device of the first embodiment of the pulling device.

FIG. 18 shows a perspective view of a second embodiment of a pulling device according to the invention.

FIG. 19 shows another perspective view of the second embodiment of a pulling device.

FIG. 20 shows a view equivalent to FIG. 19, but with one of the safety covers in an open position.

FIG. 21 shows a schematic view of a hydraulic-pneumatic circuit for activating the cleaning devices and the water outlets of the lower gutters of the second embodiment of the pulling device.

### DETAILED DESCRIPTION

The invention proposes a pulling device (10, 10′) comprising at least one rotating wheel (11, 11′), each rotating wheel (11, 11′) having a first side (11a), a second side (11b) and a circumferential surface (11c) defining a traction channel (111), each rotating wheel (11, 11′) being fixed on a shaft (13) driven by a motor (14), said motor (14) supported on a base (12). According to the invention, the pulling device (10, 10′) comprises at least one safety cover (20, 20′), each safety cover (20, 20′) having a first portion (21) and a second portion (22), the portions (21, 22) defining a closed position, in which said portions (21, 22) cover the sides (11a, 11b) of the respective rotating wheel (11, 11′), and an open position, in which at least one of the portions (21, 22) is moved away from a respective side (11a, 11b) of the respective rotating wheel (11, 11′).

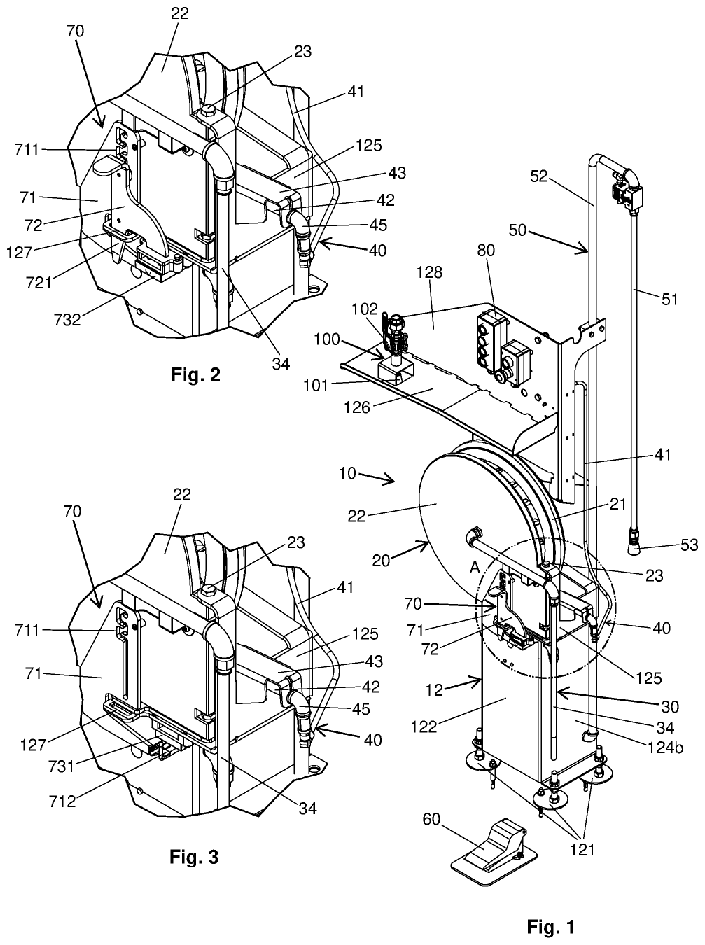

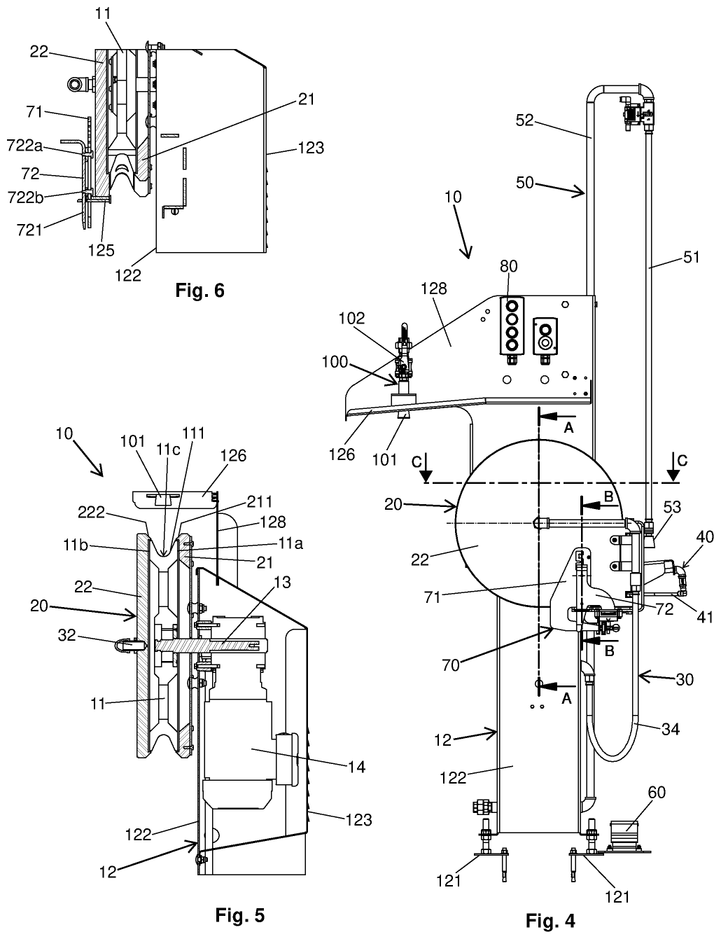

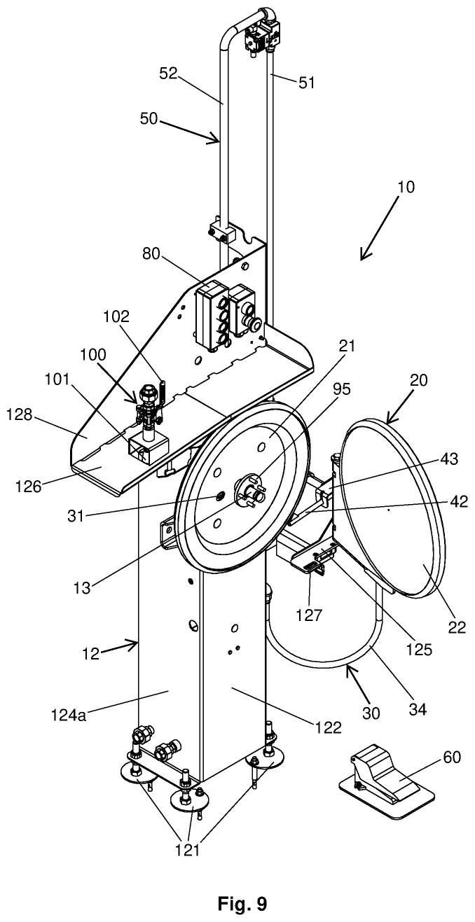

FIGS. 1 to 17 illustrate a first embodiment of a pulling device (10) comprising a single rotating wheel (11) cooperating with a single safety cover (20), said embodiment being detailed below.

To carry out the step of separating the small intestine from the viscera package, the operator makes an initial cut in the mesentery, obtaining a free end of the small intestine, which is then inserted over the traction channel (111) of the rotating wheel (11). The rotation of the rotating wheel (11) pulls the small intestine, while the operator cuts the mesentery, thus continuously separating the small intestine in order to move it away from the viscera package.

Advantageously, when the portions (21, 22) of the safety cover (20) are in the closed position, the sides (11a, 11b) of the rotating wheel (11) remain covered, in order to prevent an operator from touching the rotating wheel (11), thus preventing accidents at work. On the other hand, because the portions (21, 22) of the safety cover (20) also define an open position, it is possible to carry out any cleaning or maintenance on the rotating wheel (11) in a quick and practical way.

Preferably, in the closed position, the portions (21, 22) of the safety cover (20) partially cover the circumferential surface (11c) of the rotating wheel (11). More preferably, as shown in FIG. 5, the circumferential surface (11c) of the rotating wheel (11) has, in the axial direction, a first flat segment extending from the first side (11a), followed by a curved segment defining the traction channel (111), followed by a second flat segment extending to the second side (11b), wherein, in the closed position, each portion (21, 22) of the safety cover (20), at least partially covers the respective flat segment of the circumferential surface (11c) of the rotating wheel (11). Thus, the portions (21, 22) of the safety cover (20) form a free space between them corresponding to the traction channel (111), in order to keep said traction channel (111) of the rotating wheel (11) available for insertion and traction of the small intestine. Advantageously, this configuration increases the level of safety for the operator.

Preferably, the safety cover (20) is arranged so that, in closed position, the portions (21, 22) cover the respective sides (11, 11b) and, if applicable, part of the circumferential surface (11c) of the rotating wheel (11) with an appropriate minimum clearance to allow rotation of the rotating wheel (11).

Preferably, each portion (21, 22) of the safety cover (20) has a respective inclined wall (211, 222) converging into the traction channel (111) of the rotating wheel (11), as shown in FIG. 5. Advantageously, the inclined walls (211, 222) form an invitation that facilitates the insertion of the small intestine into the traction channel (111) of the rotating wheel (11).

Preferably, the first portion (21) of the safety cover (20) is fixed to the base (12) in a static manner in relation to the first side (11a) of the rotating wheel (11). In the embodiment shown, the first portion (21) is fixed to a front wall (122) of the base (12) by screws. Thus, the shaft (13) passes through the front wall (122) of the base (12) and the first portion (21) of the safety cover (20) and receives at its end the rotating wheel (11), as it can be seen in FIG. 5.

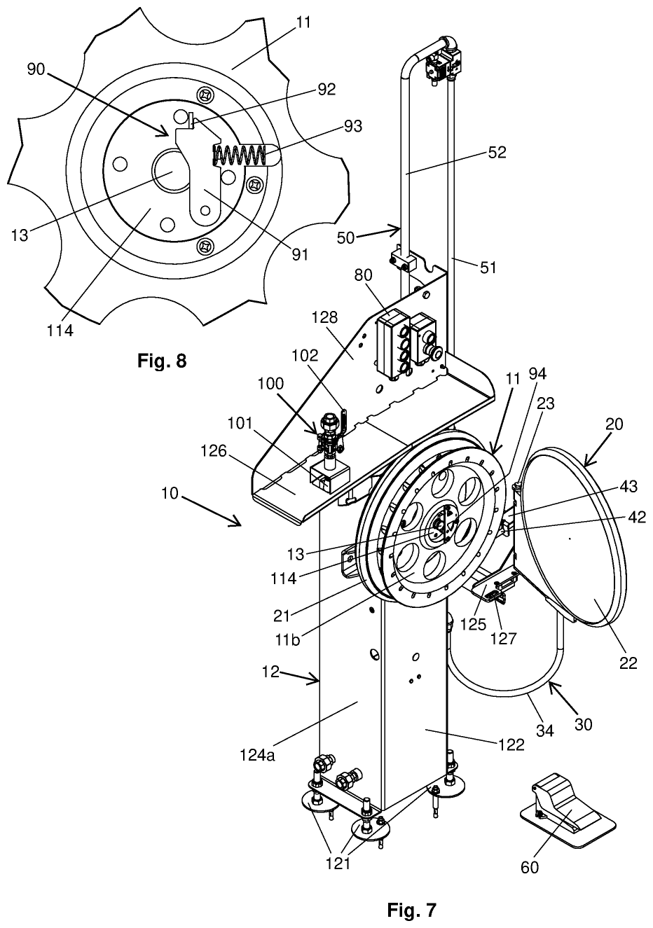

Preferably, the second portion (22) of the safety cover (20) is fixed to the base (12) in a movable manner in relation to the second side (11b) of the rotating wheel (11). In the embodiment shown, as can be best seen in FIGS. 1 to 3 and 7, the second portion (22) of the safety cover (20) is movable by means of a pivoting pin (23). More specifically, the second portion (22) is cooperative with a support (125), arranged on a side wall (124b) of the base (12), by the pivoting pin (23), in a vertical position, so that said second portion (22) can be moved between the closed position, as shown in FIG. 1, and the open position, moved away from the second side (11b) of the rotating wheel (11), as shown in FIG. 7, by the articulation around the pivoting pin (23).

Preferably, the safety cover (20) comprises a locking device (70) that in a locked position keeps the portions (21, 22) in the closed position, and in an unlocked position it allows to change the portions (21, 22) to the open position. In the embodiment shown, as can best be seen in FIGS. 2, 3 and 6, the locking device (70) comprises a latch (72) having a tongue (721) insertable in a hole (127) disposed in the base (12), the latch (72) having at least one guide pin (722a, 722b) lodged and slidable in a path (711) disposed in a guide plate (71) fixed on the second portion (22).

In the embodiment shown, as shown in FIG. 3, the path (711) has a lower portion in a linear shape and an upper portion in a sinuous shape. In turn, the latch (72) comprises an upper guide pin (722a) and a lower guide pin (722b).

In the locked position, the tongue (721) of the latch (72) remains inserted in the hole (127) of the base (12), while the lower guide pin (722b) remains in contact with a lower end of the path (711). To configure the locking device (70) in the unlocked position, it is necessary to move the latch (72) upwards, moving the guide pins (722a, 722b) along the path (711), until the upper guide pin (722a) reaches an upper end of the path (711), so that the tongue (721) of the latch (72) is removed from the hole (127).

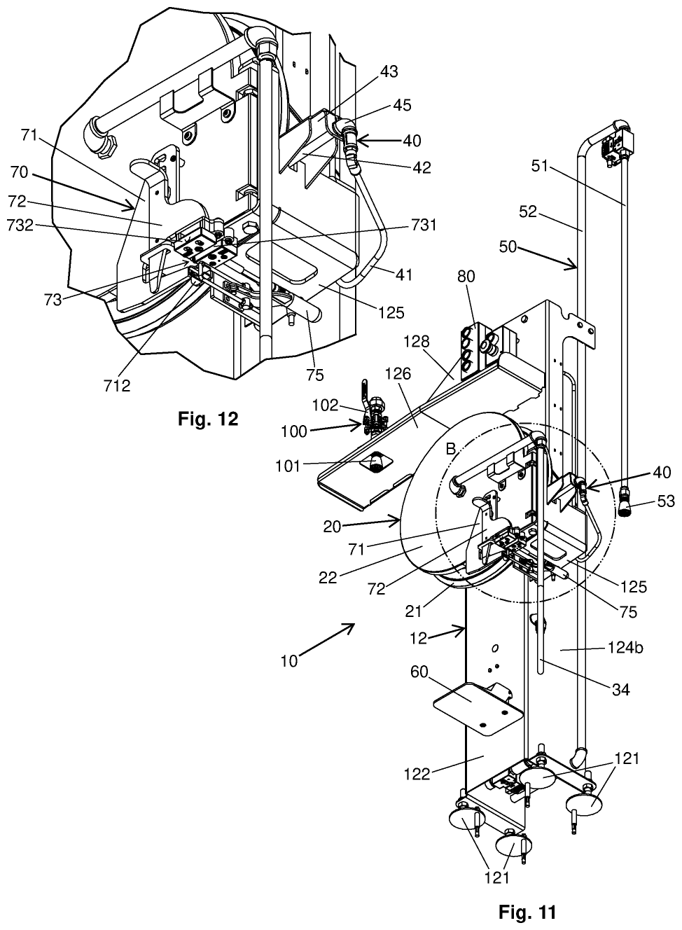

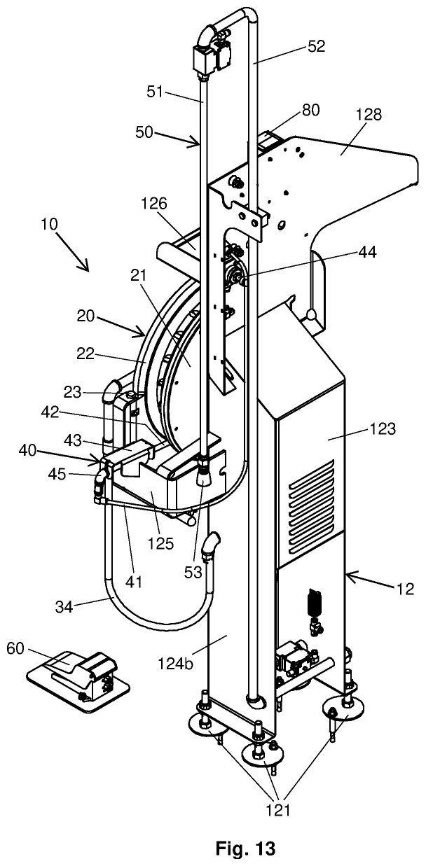

In the embodiment shown, the pulling device (10) additionally comprises a quick coupling device (75) disposed in the support (125) of the base (12), and the guide plate (71) of the locking device (70) comprises a hook (712) attachable to the quick coupling device (75). Thus, to move the second portion (22) of the safety cover (20) to the open position, it is necessary to activate the quick coupling device (75), in order to disengage it from the hook (712) present on the guide plate (71). For example, the quick coupling device (75) is of the over center latch type, as shown in detail in FIGS. 11 and 12.

To unlock the safety cover (20), the operator of the pulling device (10) must initially turn off the motor (14), by activating a shutdown button on a control panel (80) fixed to the upper plate (128) of the base (12). Afterwards, it is necessary to move the latch (72) of the locking device (70) up to the unlocked position and to disengage the quick coupling device (75) from the hook (712).

Preferably, the locking device (70) comprises a security sensor (73) having an actuation zone (731), and a sensor actuator (732), the sensor (73) and the actuator (732) arranged so that in the locked position, the actuation zone (731) detects the presence of the actuator (732). In the embodiment shown, as shown in FIG. 12, the sensor (73) is fixed to the base (12), more particularly to the support (125) of the base (12), and the sensor actuator (732) is fixed to the latch (72). During the movement of the latch (72) from the locked position to the unlocked position, the actuator (732) is moved away from the actuation zone (731), in order to deactivate the sensor (73), which in turn interrupts the power supply to the motor (14), turning it off. Thus, advantageously, the rotation of the rotating wheel (11) is automatically switched off by unlocking the locking device (70), protecting the operator against an eventual accident, in case the operator forgets to turn off the motor (14) through the shutdown button. For example, the security sensor (73) is of the electromagnetic type.

In addition, the operator takes a few seconds to move the guide pins (722a, 722b) of the latch (72) along the path (711). Thus, advantageously, sufficient time is provided for the rotating wheel (11) to cease its movement after the motor has been switched off (14), so that the operator can only move the second portion (22) of the safety cover (20) to the open position when the rotating wheel (11) is already stopped, thus protecting the operator against an eventual accident.

Preferably, the rotating wheel (11) is fixed to the shaft (13) in a removable manner by means of a coupling device (90). In the embodiment shown, as shown in FIGS. 7 to 9, the coupling device (90) comprises a hub (95) cooperating with one end of the shaft (13) to receive the rotating wheel (11), and comprises a locking plate (91) pivotally mounted on the rotating wheel (11) and being insertable into a recess arranged in the shaft (13), the locking plate (91) being pressed by a spring (93) against the recess of the shaft (13) and against a stop (92). Also, in the embodiment shown, the locking plate (91) is installed in a central recess (114) present in the rotating wheel (11), the locking plate (91) being covered by a closing plate (94) fixed on the rotating wheel (11). The rotating wheel (11) can be removed from the shaft (13) by pressing the locking plate (91) against the spring (93), in order to disengage said locking plate (91) from the recess arranged in the shaft (13). Thus, advantageously, the coupling device (90) allows the removal and replacement of the rotating wheel (11) to be carried out quickly and practically, contributing to an eventual maintenance or cleaning operation.

Preferably, the pulling device (10) comprises a first cleaning device (30) having at least one outlet nozzle (31, 32) arranged to eject water into a region internal to the safety cover (20). In operation, the pulling device (10) is subjected to waste from the interior of the small intestine. Advantageously, the actuation of the first cleaning device (30) allows washing the pulling device (10), especially in the region internal to the safety cover (20).

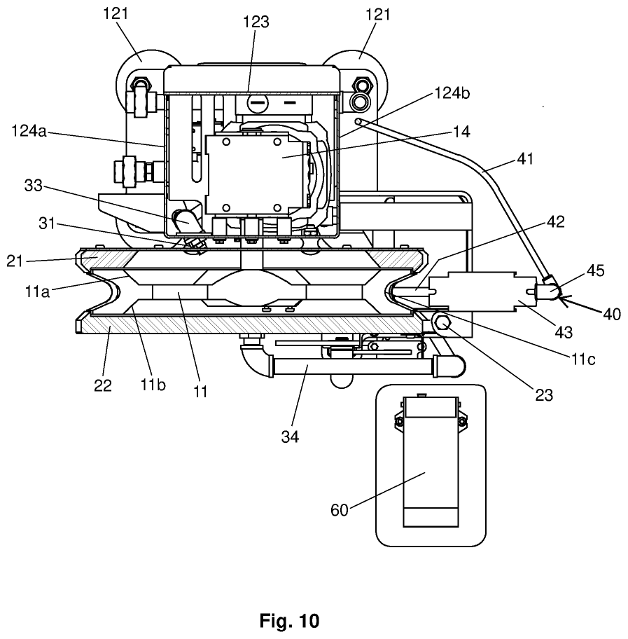

In the embodiment shown, as shown in FIGS. 5 and 10, the first cleaning device (30) has a first outlet nozzle (31) installed in the first portion (21) of the safety cover (20) to eject water towards the first side (11a) of the rotating wheel (11) and a second outlet nozzle (32) installed in the second portion (22) of the safety cover (20) to eject water towards the second side (11b) of the rotating wheel (11). Each outlet nozzle (31, 32) is connected to a respective piping (33, 34) connected to a water supply (103). In particular, the piping (34) of the second outlet nozzle (32) includes a flexible section in order to allow the opening and closing movement of the second portion (22) of the safety cover (20). When in contact with the rotating wheel (11), the water released by the outlet nozzles (31, 32) undergoes a centrifugal force generated by the movement of the rotating wheel (11) and moves towards the outer edge thereof. Alternatively, the first cleaning device (30) can be configured with just one of the outlet nozzles (31, 32).

Preferably, the pulling device (10) comprises a movable cleaning device (50) having a flexible hose (51) connected to a shower (53). In the embodiment shown, the flexible hose (51) is connected to a rigid piping (52) connected to a water supply (103). When activating the movable cleaning device (50), the operator can move the hose (51) and point the shower (53) to any point of the pulling device (10) and, thus, perform any necessary cleaning, either during the operation of the pulling device (10), or at the end of a work shift.

Preferably, the first cleaning device (30) and/or the movable cleaning device (50) comprises at least one opening and closing valve (35, 54) to control water flow to the outlet nozzle (31, 32) and/or to the shower (53). Preferably, the opening and closing valve (35, 54) is normally closed, pneumatically actuated and spring-return type, said opening and closing valve (35, 54) being actuated by a first directional control valve (107), normally closed, preferably actuated by pedal (60) and spring-return type.

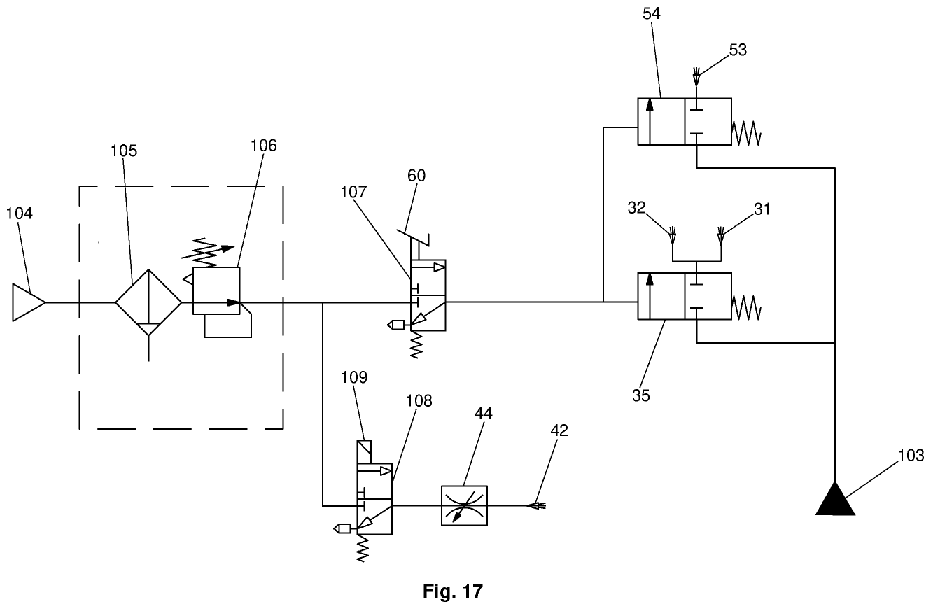

In the embodiment shown, as shown in FIG. 17, the first cleaning device (30) has a first opening and closing valve (35) to control water flow to the first and second outlet nozzle (31, 32), while the movable cleaning device (50) has a second opening and closing valve (54) to control water flow to the shower (53), both opening and closing valves (35, 54) being actuated by a directional control valve (107) actuated by pedal (60), which is connected to a pneumatic supply (104). In addition, the pneumatic circuit can include other usual elements such as filter (105) and pressure regulator (106). When the operator of the pulling device (10) actuates the pedal (60), the opening and closing valves (35, 54) are opened in order to release the water flow from the water supply (103) to the outlet nozzles (31, 32) and to the shower (53), and when the operator releases the pedal (60), the opening and closing valves (35, 54) are closed due to the return by spring return. Advantageously, the pedal actuation (60) makes it possible to operate the cleaning devices (30, 50) with the foot, preserving the operator's hands free to operate the pulling device (10) and/or to handle the hose (51). Alternatively, the opening and closing valves (35, 54) can be of other types, such as, for example, manually or electrically actuated. Alternatively, the first directional control valve (107) can have another type of actuation, such as, for example, manual or by a solenoid valve.

Preferably, the pulling device (10) comprises an injection device (40) having an outlet nozzle (42) arranged to inject compressed air towards the traction channel (111) of the rotating wheel (11). Eventually, during the pulling device (10) operation, the small intestine pulled by the rotating wheel (11) may adhere to the traction channel (111) of the said rotating wheel (11) and consequently wrap around the rotating wheel (11). Advantageously, the injection device (40) allows injecting compressed air in order to release the small intestine from the rotating wheel (11).

In the embodiment shown, as shown in FIGS. 12, 13, 16 and 17, the outlet nozzle (42) of the injection device (40) is connected to a hose (41) through a connector (45) of the knee type, said hose (41) being connected to a pneumatic supply (104). In addition, the outlet nozzle (42) may comprise a tip (46) cooperating with the traction channel (111) of the rotating wheel (11), said tip (46) serving as a guide for the positioning of the outlet nozzle (42) in relation to the traction channel (111). Particularly, in the embodiment shown, the outlet nozzle (42) is supported by a holder (43) fixed on the support (125) of the base (12), said outlet nozzle (42) being movable through a hole present in the holder (43). Thus, to remove the rotating wheel (11) from the shaft (13), it is necessary to move the outlet nozzle (42) along the holder (43), in order to move the outlet nozzle (42) away from the rotating wheel (11) until it is possible to remove the rotating wheel (11) from the shaft (13) without any interference from the rotating wheel (11) with the outlet nozzle (42).

Preferably, as shown in FIG. 17, the injection device (40) comprises a flow control valve (44) to control the compressed air flow directed to the outlet nozzle (42), and a second directional control valve (108) to control the passage of compressed air to the outlet nozzle (42). The second directional control valve (108) is a normally closed type, preferably actuated by a solenoid valve (109) and spring-return type. In addition, the pneumatic circuit can include other usual elements such as filter (105) and pressure regulator (106). In the embodiment shown, the flow control valve (44) is manually actuated. In the embodiment shown, the solenoid valve (109) is indexed to the actuation of the rotating wheel (11), that is, while the rotating wheel (11) is driven, the solenoid valve (109) receives an electrical signal that commands the opening of the second directional control valve (108), releasing the passage of compressed air from the pneumatic supply (104) to the outlet nozzle (42), and when the rotating wheel (11) is deactivated, the solenoid valve (109) stops receiving the electrical signal and the second directional control valve (108) closes due to the spring return. Alternatively, the solenoid valve (109) can be connected to a specific actuation button for the purpose of turning on or off the air injection through the outlet nozzle (42). Alternatively, the second directional control valve (108) can have another type of actuation, such as, for example, manual.

In the embodiment shown, the base (12) of the pulling device (10) is fixed to the floor by four support feet (121) and comprises a front wall (122), a rear wall (123), a first side wall (124a) and a second side wall (124b). Additionally, the base (12) comprises an upper plate (128) that supports a protector (126) disposed above the rotating wheel (11), the protector (126) being responsible for blocking the dirt released during the traction of the small intestine.

Preferably, the pulling device (10) comprises a second cleaning device (100) having a shower (101) connected to a water supply, the shower (101) being installed in an appropriate position to eject water towards a small intestine pulled by the rotating wheel (11). Advantageously, the second cleaning device (100) allows to perform an external washing in the small intestine to remove any dirt. Preferably, the second cleaning device (100) comprises an opening and closing valve (102) for controlling the water flow to the shower (101). In the embodiment shown, the opening and closing valve (102) is manually actuated. Alternatively, the opening and closing valve can be of another type, such as, for example, pneumatically or electrically actuated. In the embodiment shown, the second cleaning device (100) is fixed to the protector (126) in such a way that the shower (101) passes through an opening in the protector (126), as shown in FIGS. 1 and 11.

In an alternative embodiment, the pulling device (10) can comprise only the first cleaning device (30), or only the second cleaning device (100), or just the movable cleaning device (50), or any combination of two cleaning devices (30, 100, 50).

In the embodiment shown, as shown in FIG. 5, the motor (14) is fixed inside the base (12), more specifically on the front wall (122), by screws, and receives the shaft (13) in the horizontal position. In the embodiment shown, the motor (14) is electric. The control panel (80) includes a motor actuation button and a shutdown button (14), and may include other usual elements, such as indicator lights and an emergency stop button. Alternatively, a hydraulic motor or a pneumatic motor can be used.

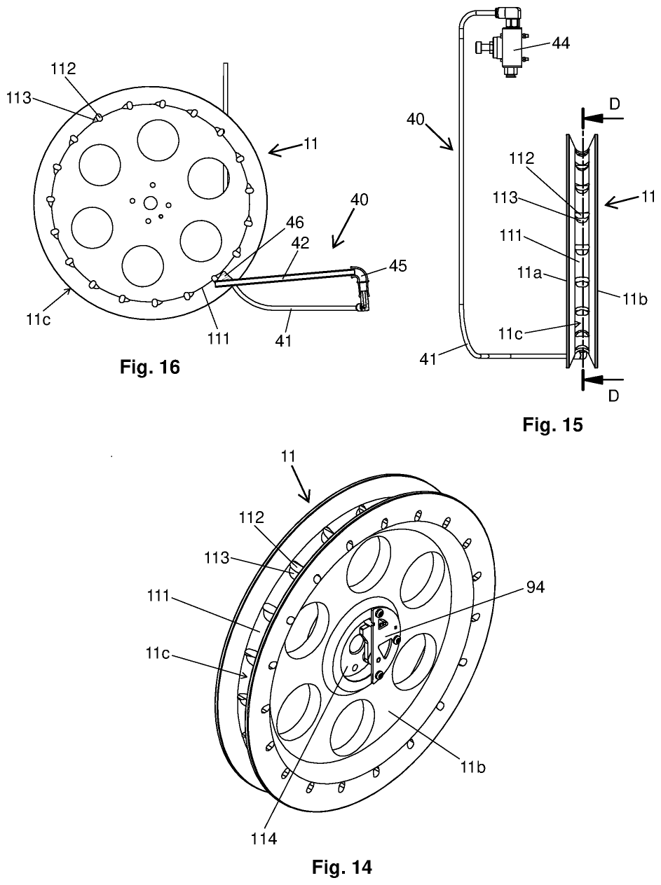

Preferably, as shown in FIGS. 14 to 16, the traction channel (111) comprises a plurality of axial grooves (112) spaced from each other, each axial groove (112) being followed by a respective circumferential recess (113). Each axial groove (112) is an oblong hole through the first side (11a) and the second side (11b) of the rotating wheel (11). Advantageously, the grooves (112) and recesses (113) assist in traction of the small intestine, preventing it from sliding over the traction channel (111).

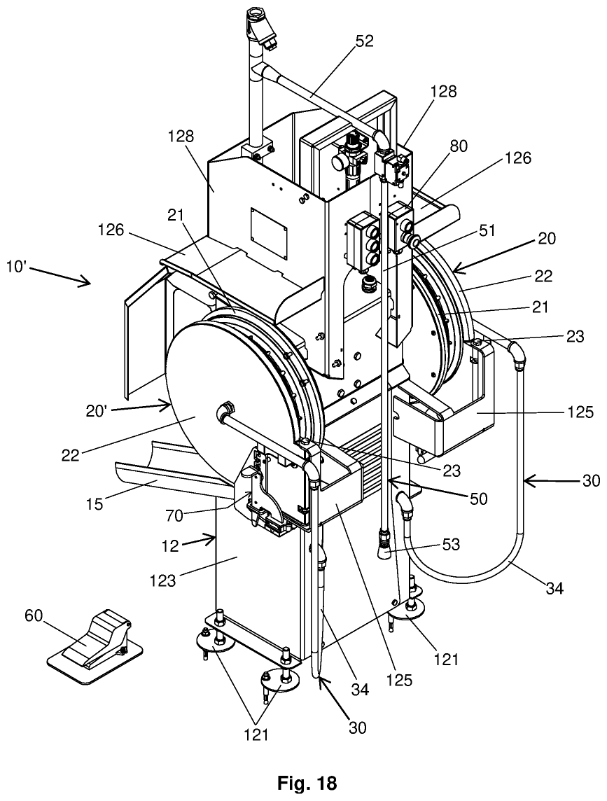

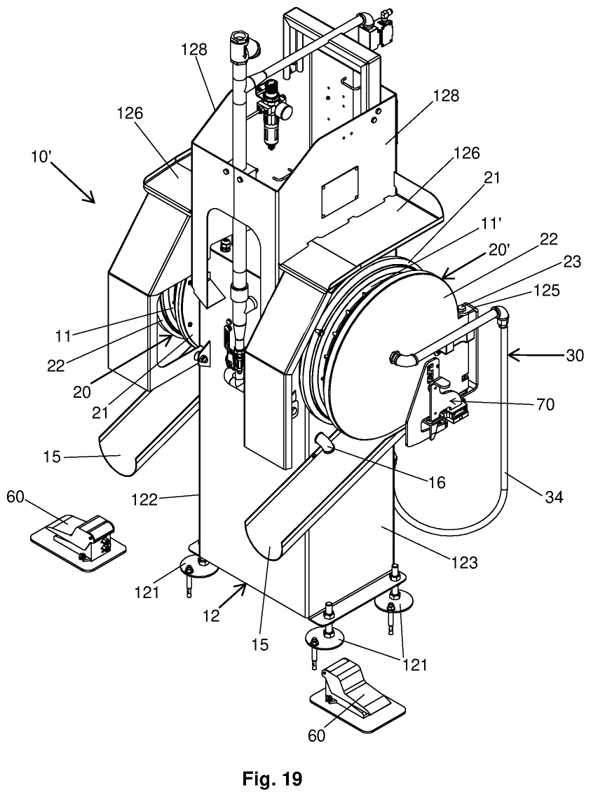

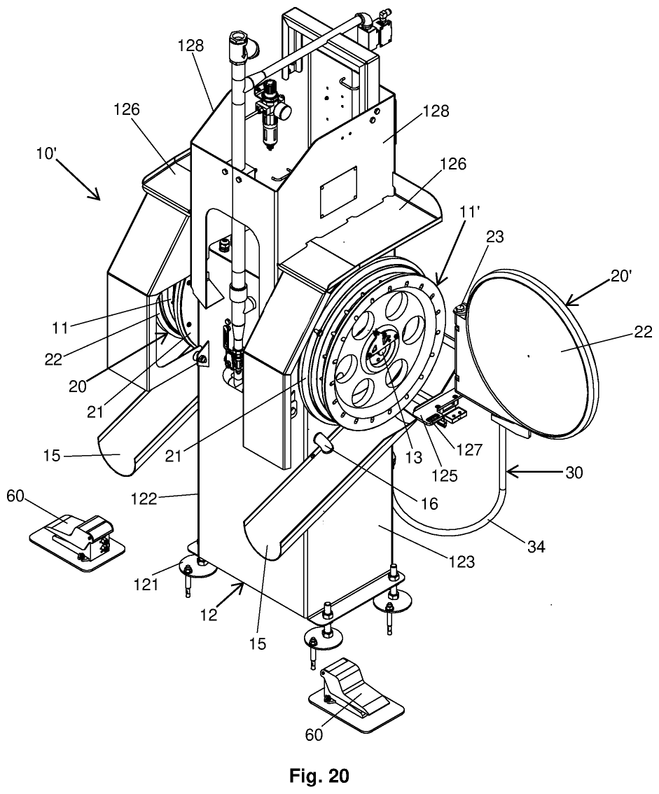

FIGS. 18 to 21 illustrate a second embodiment of pulling device (10′) comprising a first safety cover (20) cooperating with a first rotating wheel (11), and a second safety cover (20′) cooperating with a second rotating wheel (11′). Each rotating wheel (11, 11′) and each safety cover (20, 20′) of the second embodiment of the pulling device (10′) is analogous to the rotating wheel (11) and safety cover (20) of the first embodiment of the pulling device (10), as well as the other features of the second embodiment of the pulling device (10′) are analogous to the features of the first embodiment of the pulling device (10), except for the following particularities.

The first portion (21) of the first safety cover (20) is fixed to a front wall (122) of the base (12) by screws, and the first portion (21) of the second safety cover (20′) is fixed to a rear wall (123) of the base (12) by screws. On the one hand, the shaft (13) passes through the front wall (122) of the base (12) and the first portion (21) of the first safety cover (20), and a first end of the shaft (13) receives the first rotating wheel (11). On the other hand, the shaft (13) passes through the rear wall (123) of the base (12) and the first portion (21) of the second safety cover (20′), and a second end of the shaft (13) receives the second rotating wheel (11′). Thus, a single motor (14) drives a single shaft (13) that drives both rotating wheels (11, 11′). Alternatively, according to another embodiment, a first motor may be responsible for driving a first shaft that drives the first rotating wheel, and a second motor may be responsible for driving a second shaft that drives the second rotating wheel.

Preferably, the pulling device (10′) comprises a lower gutter (15) positioned below each safety cover (20, 20′), in order to guide the portion of the small intestine already pulled by the respective rotating wheel (11, 11′). Preferably, each lower gutter (15) has a downward slope from the center of the respective rotating wheel (11, 11′) towards the exit side of the pulled small intestine. In the embodiment shown, a first lower gutter (15) is fixed to the front wall (122) of the base (12) and a second lower gutter (15) is fixed to the rear wall (123) of the base (12). Preferably, the pulling device (10′) comprises a water outlet (16) positioned over each lower gutter (15), in order to facilitate the sliding of the small intestine over the respective lower gutter (15). Optionally, the first embodiment of the pulling device (10) can comprise a lower gutter and water outlet analogous to one of the lower gutters (15) and water outlets (16) of the second embodiment of the pulling device (10′).

In the embodiment shown, the second embodiment of the pulling device (10′) is not equipped with the injection device (40) and the second cleaning device (100) described in the first embodiment of the pulling device (10). Alternatively, the second embodiment of the pulling device (10′) could be equipped with said devices (40, 100).

According to the second embodiment, the pulling device (10′) comprises a first cleaning device (30) having a first outlet nozzle (31) and a second outlet nozzle (32) installed in the first safety cover (20), and a first cleaning device (30) having a first outlet nozzle (31) and a second outlet nozzle (32) installed in the second safety cover (20′), each first cleaning device (30) being analogous to the first cleaning device (30) of the first embodiment of the pulling device (10). In addition, the second embodiment of the pulling device (10′) is equipped with a movable cleaning device (50) having a shower (53) analogous to the movable cleaning device (50) of the first embodiment of the pulling device (10).

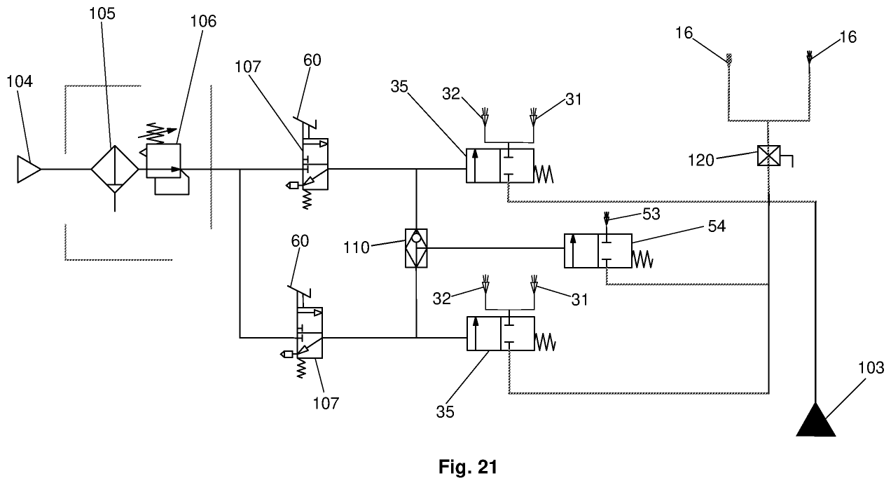

Regarding the actuation, as shown in FIG. 21, each cleaning device (30) has a respective first opening and closing valve (35) to control the water flow to the respective outlet nozzles (31, 32), each first opening and closing valve (35) being actuated by a respective directional control valve (107) actuated by foot pedal (60), connected to a pneumatic supply (104). In addition, the pneumatic lines that feed each first opening and closing valve (35) are connected to the inlets of an opening or closing valve (110), which has its outlet connected to a second opening and closing valve (54) to control water flow to the shower (53) of the movable cleaning device (50). In addition, the pneumatic circuit can include other usual elements such as filter (105) and pressure regulator (106).

When an operator of the pulling device (10′) actuates the pedal (60) of one of the directional control valves (107), the respective first opening and closing valve (35) is opened in order to release the water flow from the water supply (103) to the respective outlet nozzles (31, 32). The actuation of one of the directional control valves (107) causes, due to the presence of the valve or (110), simultaneously the opening of the second opening and closing valve (54), releasing the water flow from the water supply (103) to the shower (53). When the operator releases said pedal (60), the respective first opening and closing valve (35) and the second opening and closing valve (54) are closed due to the spring return. Alternatively, the opening and closing valves (35, 54) can be of other types, such as, for example, manually or electrically actuated. Alternatively, the first directional control valve (107) can have another type of actuation, such as, for example, manual or by a solenoid valve.

In addition, the water outlets (16) of the lower gutters (15) are connected to the water supply (103) and an opening and closing valve (120). In the embodiment shown, said opening and closing valve (120) is manually actuated. Alternatively, this opening and closing valve can be of another type, such as, for example, pneumatically or electrically actuated.

The second embodiment of the pulling device (10′) allows the simultaneous work of two operators, each operator being responsible for feeding one of the rotating wheels (11, 11′).

The preferred or alternate embodiments described herein are not intended to limit the invention to the structural forms, and constructive variations may be equivalent without, however, departing from the scope of protection of the invention.

1.-22. (canceled)

23. A pulling device comprising at least one rotating wheel, each rotating wheel having a first side, a second side and a circumferential surface defining a traction channel, each rotating wheel being fixed on a shaft driven by a motor, said motor supported on a base, the pulling device wherein comprising at least one safety cover, each safety cover having a first portion and a second portion, the portions defining a closed position, in which said portions cover the sides of the respective rotating wheel, and an open position, in which at least one of the portions is moved away from a respective side of the respective rotating wheel.

24. The pulling device according to claim 23, wherein comprising a first safety cover cooperating with a first rotating wheel, and a second safety cover cooperating with a second rotating wheel.

25. The pulling device according to claim 23, wherein in the closed position, the portions of each safety cover partially cover the circumferential surface of the respective rotating wheel.

26. The pulling device according to claim 25, wherein the circumferential surface of each rotating wheel has, in axial direction, a first flat segment extending from the first side, followed by a curved segment defining the traction channel, followed by a second flat segment extending to the second side,
wherein, in the closed position, each portion of each safety cover at least partially covers the respective flat segment of the circumferential surface of the respective rotating wheel.

27. The pulling device according to claim 23, wherein each portion of each safety cover has a respective inclined wall converging into the traction channel of the respective rotating wheel.

28. The pulling device according to claim 23, wherein the first portion of each safety cover is fixed to the base in a static manner in relation to the first side of the respective rotating wheel, and the second portion of each safety cover is fixed to the base in a movable manner in relation to the second side of the respective rotating wheel.

29. The pulling device according to claim 28, wherein the second portion of each safety cover is movable by means of a respective pivoting pin.

30. The pulling device according to claim 23, wherein each safety cover comprises a locking device having a locked position in which the portions of the respective safety cover are maintained in the closed position, and an unlocked position in which the portions of the respective safety cover are able to be changed to the open position.

31. The pulling device according to claim 30, wherein each locking device comprises a latch having a tongue insertable in a respective hole disposed in the base, the latch having at least one guide pin lodged and slidable in a path disposed in a respective guide plate fixed on the second portion of each safety cover.

32. The pulling device according to claim 30, wherein each locking device comprises a security sensor having an activation zone, and a sensor actuator, the sensor and the actuator arranged such that in the locked position the activation zone detects the actuator.

33. The pulling device according to claim 31, wherein each sensor is fixed to the base and each sensor actuator is fixed to the respective latch.

34. The pulling device according to claim 23, wherein each rotating wheel is fixed to the shaft in a removable manner by means of a respective coupling device.

35. The pulling device according to claim 34, wherein each coupling device comprises a hub cooperating with an end of the shaft to receive the respective rotating wheel and comprises a locking plate pivotally mounted on the respective rotating wheel, the locking plate being insertable into a recess arranged in the shaft, and the locking plate being pressed by a spring against the recess of the shaft and against a stop.

36. The pulling device according to claim 23, wherein each safety cover comprises a first cleaning device having at least one outlet nozzle arranged to eject water into a region internal to the safety cover.

37. The pulling device according to claim 36, wherein each first cleaning device has a first outlet nozzle installed in the first portion of each safety cover to eject water towards the first side of the respective rotating wheel and/or a second outlet nozzle installed in the second portion of each safety cover to eject water towards the second side of the respective rotating wheel.

38. The pulling device according to claim 23, wherein comprising a movable cleaning device having a flexible hose connected to a shower.

39. The pulling device according to claim 36, wherein each first cleaning device and/or the movable cleaning device comprises at least one opening and closing valve to control water flow to the outlet nozzle and/or to the shower.

40. The pulling device according to claim 39, wherein the opening and closing valve is normally closed, pneumatically actuated and spring-return type, said opening and closing valve being actuated by a first directional control valve, normally closed, preferably actuated by pedal and spring-return type.

41. The pulling device according to claim 23, wherein comprising a second cleaning device having a shower connected to a water supply, the shower installed in an appropriate position to eject water towards a small intestine pulled by the respective rotating wheel.

42. The pulling device according to claim 23, wherein comprising an injection device having an outlet nozzle arranged to inject compressed air towards the traction channel of the respective rotating wheel.

43. The pulling device according to claim 42, wherein the injection device comprises a second directional control valve to control compressed air flow to the outlet nozzle, the second directional control valve being normally closed, preferably actuated by a solenoid valve and spring-return type.

44. The pulling device according to claim 23, wherein comprising a lower gutter positioned below each safety cover, and preferably comprises a water outlet positioned over each lower gutter.
